(19) United States
(12) Patent Application Publication
(10) Pub. No.: US 2014/0065402 A1
(43) Pub. Date: Mar. 6, 2014

(54) HYBRID PANI/CARBON NANO-COMPOSITES FOR PRODUCTION OF THIN, TRANSPARENT AND CONDUCTIVE FILMS

(71) Applicant: Technion Research and Development Foundation Ltd., Haifa (IL)

(72) Inventors: Ran Yosef SUCKEVERIENE, Karmiel (IL); Moshe NARKIS, Karmiel (IL)

(73) Assignee: Technion Research and Development Foundation Ltd., Haifa (IL)

(21) Appl. No.: 14/016,903

(22) Filed: Sep. 3, 2013

Related U.S. Application Data
(60) Provisional application No. 61/696,184, filed on Sep. 2, 2012.

(51) Int. Cl. H01B 1/04; H01B 13/00

(52) U.S. Cl. CPC H01B 1/04; H01B 13/0026
USPC 428/220; 252/511; 156/242; 428/426; 428/477.7; 428/447; 428/480; 428/537.5; 428/688

(57) ABSTRACT

The present invention relates to hybrid electrically conducting systems comprising a matrix of a conducting polymer (polyaniline-PANI), and highly conducting carbonaceous nanoparticles, e.g., carbon nanotubes (CNT) or graphenes. The PANI/carbon nano-composites are prepared by a novel process comprising the steps of (a) polymerizing aniline and carbonaceous nanoparticles by inverse emulsion polymerization conducted under sonication, so as to obtain PANI/carbon nano-composites; (b) de-doping the PANI/carbon nano-composites obtained in step (a); (c) re-doping the PANI/carbon nano-composites obtained in step (b); and (d) forming a film from the re-doped PANI/carbon nano-composites. The PANI/carbon nano-composites are used for the preparation of thin, transparent, and conductive films which can be applied to a variety of substrates and used for commercial applications.

### RELATED APPLICATION

This application claims the benefit of and priority from U.S. Provisional Application No. 61/696,184, filed on Sep. 2, 2012, the entirety of which is incorporated herein by reference for the teachings therein.

### FIELD OF THE INVENTION

The present invention relates to hybrid electrically conducting systems comprising a matrix of a conducting polymer (polyaniline-PANI), and highly conducting carbonaceous nanoparticles, e.g., carbon nanotubes (CNTs) or graphene. The PANI/carbon nano-composites are prepared by a novel process and are used for the preparation of thin, transparent, and conductive films which can be applied to a variety of substrates.

### BACKGROUND OF THE INVENTION

Thin transparent conducting oxide (TCO) films are widely used for the preparation of many commercial products, such as touch screens, photovoltaic cells, flexible displays, and more. Thin transparent film requirements are surface resistance of about 500 Ω/□ or less, about 80% or higher transparency in the visible region (VLT) [1, 2], and good adhesion to the substrate surface. The market for thin transparent, conducting films is estimated at more than 3.5 billon US dollars for 2012. The main TCO uses tin doped indium oxide (ITO), which alone is estimated to be a 3.2 billion US dollar market in 2012, with a 20% growth rate expected through 2013. However, ITO films are unlikely to satisfy future needs due to the escalating cost of indium which is in limited supply. It is currently estimated that indium will be fully consumed within 20 years [3, 4].

In order to overcome this problem, while meeting the market's growing demand, several alternatives have been introduced. Two main alternatives currently investigated are carbon nanotubes (CNTs) and electrically conductive polyaniline (PANI) [2-6]. CNTs have drawn much attention in recent years, since their first observation by Iijima [7]. There are several types of CNTs: single wall nanotubes (SWNT), double wall nanotubes (DWNT) and multi wall nanotubes (MWNT) consisting, respectively, of single, double or multiple concentric cylindrical shells of graphite sheets. An important characteristic of the structure is the “helicity” of the carbon honeycomb with respect to the tube axes [7]. CNT possess a remarkable combination of properties, i.e., high strength and stiffness along with flexibility accompanied with high electrical and thermal conductivity, thus offering opportunities for development of new nano-composites [8]. However, CNTs tend to agglomerate into bundles, thus losing their unique properties. Several attempts have been made to overcome agglomeration of the nanotubes: (i) applying ultrasonic energy; (ii) functionalizing CNTs by chemical reactions with strong acids, silanes etc., and (iii) in situ polymerization of monomers in the presence of CNTs.

Over the past several years, research has focused on methods of in situ polymerization of monomers in the presence of nano-particles, and intercalation polymerization processes [9,10]. Since CNT have poor solubility in most solvents and poor compatibility in polymeric matrices, fine dispersions are difficult to achieve. Ginic-Markovic et al. [8] described a method of ultrasonic emulsion polymerization of aniline in the presence of CNT. This process decreases agglomeration of CNT, creating a micelle structure around the CNT which becomes “soluble” in water for a certain period of time. This in situ polymerization method allows the production of wrapped and stabilized nanotubes by PANI. Konyushenko et al. [11], Guo et al. [12], and Zhang et al. [13] also described multi-walled CNT coating with PANI via an in situ polymerization method. There are several methods of production of PANI, one of which presented by Soares et al. [14] describes an inverted emulsion polymerization method of aniline in toluene. Zelikman et al. [15] describe a sonicated in situ inverse emulsion polymerization method for the preparation of PANI/CNT nanofibers, in which very small water dispersed droplets (containing ammonium peroxydisulfate (APS) as an oxidizing agent), formed by ultrasonic field, meet continuous toluene medium (containing aniline and dodecyl benzene sulfonic acid (DBSA)). At the interfaces APS radicals in the aqueous droplets collide with the aniline/DBSA (anilinium complex) dispersed in the organic phase, thus PANI forms at the interfaces. The reaction conducted under sonication resulting in PANI coated MWNTs, is reportedly very fast, as compared with inverse emulsion polymerization conducted in the absence of sonication, which tends to be slow [14].

Suckeveriene et al. [16] describes the synthesis of hybrid PANI/CNT nano-composites by dynamic interfacial inverse emulsion polymerization under sonication.

Currently there is no commercial production of CNT-based transparent, conductive films. The main limitations of the known solutions are poor adhesion to the substrate surfaces. Various additives can improve adhesion, but this typically results in inadequate surface resistivity and transparency, and thus no sustainable product is available. Accordingly, there are currently no CNT and/or conductive polymer-based thin films available on the market, which provide the required properties for a thin conductive film (acceptable transparency, conductivity, adhesion and haze). As the sources of indium, and consequently ITO films are depleting, there is an urgent need to develop fast, reliable and cost-effective methods for preparing alternative conductive films, that are suitable for use in commercial applications.

### SUMMARY OF THE INVENTION

The present invention relates to a new process for production of thin, conducting and transparent PANI/carbon films of characteristics close to or meeting industrial requirements, currently only met by ITO films. The present invention further relates to PANI/carbon films prepared by such process, and their use for the preparation of thin, transparent, and conductive films which can be applied to a variety of substrates.

The present invention relates to a new in-situ inverse emulsion polymerization process of aniline in the presence of carbonaceous nanoparticles in organic solvents using ultrasonication. Various carbonaceous nanoparticles were investigated, including: single-walled carbon nanotubes (SWNT), double-walled carbon nanotubes (DWNT), multi-walled carbon nanotubes (MWNT), several types of graphene, carbon fibers and carbon black. In one embodiment of the dynamic inverse polymerization process of the present invention, carbonaceous nanoparticles were coated with polyaniline (PANI) under sonication. PANI dispersion, as reference, and PANI/carbon dispersions were stable for long periods of time without visible precipitation. High-resolution scanning electron microscopy (HRSEM) shows that the carbonaceous nanoparticles are coated with PANI, leading to remarkably improved dispersability of the nanotubes, thus the PANI coating reduces the tendency of the carbonaceous nanoparticles to re-agglomerate. The neat carbonaceous nanoparticles, such as the CNTs, have a diameter of ˜10 nm, while the core-shell PANI/carbon nanofibers exhibit a diameter of ˜40 nm. The dispersions obtained may have important potential applications in the fields of sensors, acoustic actuators, semi-conductors, solar cells, etc. The PANI/carbon nano-composites are useful for film formation using a series of coating rods to produce films of different thicknesses. The films' resistivity and light transparency decrease while haze increases as the film thickness increases.

The process of the present invention results in PANI/carbon nano-composite films having values of ˜80% VLT, ˜650 Ω/□ (2-point probe), and ˜100 Ω/□ (4-point probe), with good adhesion to the substrate surface, using hybrid PANI/carbon dispersions prepared by the process as described herein. In some embodiments, the PANI/carbon nano-composites are characterized by one or more of a surface resistivity of equal to or less than about 1,000 Ω/□, preferably less than about 650 Ω/□, more preferably less than about 500 Ω/□, most preferably less than about 100 Ω/□; a transparency of equal to or greater than about 80%; haze of equal to or less than about 10%; and good adhesion to multiple substrates (pass tape test, ASTM 3359D).

The PANI/carbon nano-composite films of the present invention have characteristics that are close to or that meet market requirements, currently only met by ITO films. The preparation of such films is very fast, inexpensive, and repeatable, thus reducing dramatically the time and cost of the films' preparation. As such, the films of the present invention offer a significant advantage over the prior art. Some advantages of the process of the present invention are:
1) A unique and very fast inverse emulsion polymerization under sonication polymerization process.
2) The PANI formed coats the carbonaceous nanoparticles very efficiently, thus resulting in improved dispersion and stable dispersions.
3) The PANI/carbon dispersions were used for the preparation of highly conductive, flexible films, with good adhesion, low haze and transparent films.

Thus, in one embodiment, the present invention relates to a process for preparing a polyaniline (PANI)/carbon nano-composite conductive film, the process comprising the steps of:
(a) polymerizing aniline and carbonaceous nanoparticles by inverse emulsion polymerization conducted under sonication, so as to obtain PANI/carbon nano-composites;
(b) de-doping the PANI/carbon nano-composites obtained in step (a);
(c) re-doping the PANI/carbon nano-composites obtained in step (b); and
(d) forming a film from the re-doped PANI/carbon nano-composites.

In some embodiments, the polymerization step (a) comprises (i) forming a solution of aniline and a dopant in an organic solvent; and (ii) adding a polymerization initiator and carbonaceous nanoparticles, wherein the carbonaceous nanoparticles are added in situ prior to initiation of polymerization, or ex situ after polymerization.

Although inverse emulsion polymerization is currently preferred, it is apparent to a person of skill in the art that other polymerization techniques known to a person of skill in the art may be used in step (a) to polymerize aniline.

As contemplated herein, the applicants have discovered that the properties of PANI/carbon nano-composites obtained by inverse emulsion polymerization techniques under sonication, can be improved by a treatment step which includes de-doping the PANI/carbon nano-composites to obtain a de-doped product, and re-doping the de-doped product. In some embodiments, de-doping is obtained by a process comprising the steps of (i) removing the organic solvent; (ii) washing the resulting PANI/carbon solids with a base; (iii) filtering and washing with water (e.g., distilled water) until a pH of about 6-7 is achieved; and (iv) drying. Any base can be used for this step. A currently preferred base is ammonium hydroxide. In some embodiments, the de-doped PANI/carbon solids are subjected to grinding using conventional grinding techniques, e.g., a ball mill or a mortar and pestle.

The conductive films formed by the process of the present invention are characterized by one or more of the following properties:
1. Surface resistivity about ≦1000 Ω/□, preferably about ≦650 Ω/□, more preferably about ≦500 Ω/□, even more preferably ≦100 Ω/□.
2. Transparency about ≧80%.
3. Haze about ≦10%.
4. Adhesion to the substrate—Pass tape test, ASTM 3359D (the test is described, e.g., in http://www.astm.org/Standards/D3359.htm).
5. Flexibility.
6. Wear/scratch resistance.

Thus, in one embodiment, the present invention relates to a PANI/carbon nano-composite conductive film, having a surface resistivity of equal to or less than about 1,000 Ω/□, preferably less than about 650 Ω/□, more preferably less than about 500 Ω/□, most preferably less than about 100 Ω/□; a transparency of equal to or greater than about 80%; haze of equal to or less than about 10%; and which is adherable to a substrate (pass tape test, ASTM 3359D).

Thus, PANI/carbon films obtained by the process of the present invention have improved properties that make them suitable for use as conductive films on multiple substrates in commercial products such as, but not limited to touch screens, photovoltaic cells, flexible displays, and more. The applicants have unexpectedly discovered that the novel process of the invention results in thin transparent films with acceptable surface resistance and transparency and low haze, while at the same time having good adhesion properties to multiple substrates. The ability to generate PANI/carbon conductive films that meet the market requirements for surface resistance, transparency and haze, while having good adhesion properties, was not possible using the processes of the prior art.

In some embodiments, the conductive PANI/carbon nano-composite film has a surface resistivity of equal to or less than about 1,000 Ω/□. In some embodiments, the conductive PANI/carbon nano-composite film has a surface resistivity of equal to or less than about 650 Ω/□. In some embodiments, the conductive PANI/carbon nano-composite film has a surface resistivity of equal to or less than about 500 Ω/□. In some embodiments, the conductive PANI/carbon nano-composite film has a surface resistivity of equal to or less than about 100 Ω/□. In other embodiment, the conductive PANI/carbon nano-composite film has a transparency of equal to or greater than about 80%. In other embodiments, the conductive PANI/carbon nano-composite film has a haze of equal to or less than about 10%. In other embodiments, the conductive PANI/carbon nano-composite film has a thickness of equal to or less than about 1,200 nm. In other embodiments, the concentration of carbonaceous nanoparticles in said conductive PANI/carbon nano-composite is equal to or less than about 3%. In some embodiments, the carbonaceous nanoparticles are selected from carbon nanotubes (CNT) and various types of graphene. In some embodiments, the CNT comprises single-walled carbon nanotubes (SWNT). In other embodiments, the CNT comprises double-walled carbon-nanotubes (DWNT). In other embodiments, the CNT comprises multi-walled carbon nanotubes (MWNT). Combinations of SWNT, DWNT, MWNT and/or graphene are also contemplated. In other embodiments, the carbonaceous nanoparticles comprise carbon black. In other embodiments, the carbonaceous nanoparticles comprise carbon nanofibers. Each possibility represents a separate embodiment of the present invention. Any dopant can be used in the process of the present invention. Non-limiting examples of suitable dopants are (±)-camphor-10-sulfonic acid (β) (CSA), para-toluene sulfonic acid (pTSA), dodecyl benzene sulfonic acid (DBSA), and linear-DBSA. Each possibility represents a separate embodiment of the present invention.

The polymerization initiator can be, e.g., an oxidizing agent, such as ammonium peroxydisulfate (APS).

As explained above, the PANI/carbon nano-composite films of the present invention can be applied to a multiplicity of substrates, for example silica, silicone, germanium, polyethylene terphthalate (PET), glass, polyamides, paper and the like. Each possibility represents a separate embodiment of the present invention. Thus, in one embodiment, the present invention further relates to a composition comprising the PANI/carbon nano-composite film of the present invention, adhered onto a substrate.

In another embodiment, the present invention relates to a PANI/carbon nano-composite conductive film, which is prepared in accordance with the process as described herein.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1: Schematic illustration of the polymerization process of the present invention. FIG. 1A: polymerization step. FIG. 1B: de-doping step. FIG. 1C: re-doping step.

FIG. 2: Image of thin, transparent and highly conductive film (value shown ˜747 Ω/□) produced by the polymerization process of the present invention. The reported value is higher than actual due to high contact resistivity.

FIG. 3: Flexible, thin, transparent and highly conductive film (values shown ˜891-892 Ω/□) produced by the polymerization process of the present invention. The reported value is higher than actual due to high contact resistivity.

FIG. 4: Representative image of one type of graphene particles used in the process of the present invention.

FIG. 5: TEM images of sprayed dispersions: (A) neat PANI; and (B) PANI/CNT.

FIG. 6: HRSEM images of (A) neat MWNT, and (B) MWNT/PANI.

FIG. 7: HRSEM images of dry film deposited from PANI/CNT dispersion (A) before and (B), (C) after post treatment.

FIG. 8: HRSEM images of dry film cross-section deposited from PANI/CNT dispersion (A) before and (B) after post treatment.

FIG. 9: HRSEM images of dry film deposited from PANI emulsion (A) before and (B), (C) after post treatment.

### DETAILED DESCRIPTION OF THE PRESENT INVENTION

The present invention relates to hybrid electrically conducting systems comprising a matrix of a conducting polymer (polyaniline-PANI), and highly conducting carbonaceous nanoparticles, e.g., carbon nanotubes (CNT), graphenes, carbon nanofibers or carbon black (collectively designated herein “PANI/carbon nano-composites”). The PANI/carbon nano-composites are characterized by one or more of a surface resistivity of equal to or less than about 1,000 Ω/□, preferably less than about 650 Ω/□, more preferably less than about 500 Ω/□, most preferably less than about 100 Ω/□; a transparency of equal to or greater than about 80%; haze of equal to or less than about 10%; and good adhesion to multiple substrates (pass tape test, ASTM 3359D).

The PANI/carbon nano-composite films of the invention are prepared by a novel process which comprises (a) polymerizing aniline and carbonaceous nanoparticles (e.g., CNTs, graphenes, carbon nanofibers or carbon black) by inverse emulsion polymerization conducted under sonication, so as to obtain PANI/carbon nano-composites, wherein the carbonaceous nanoparticles are added in situ prior to by initiation of polymerization, or ex situ after polymerization; (b) de-doping the obtained PANI/carbon nano-composites; (c) re-doping the PANI/carbon nano-composites; and (d) forming a film from the re-doped PANI/carbon nano-composites. The PANI/carbon nano-composites are used for the preparation of thin, transparent, and conductive films which can be applied to a variety of substrates and used for commercial applications. The process of the invention is characterized by:
1. Inverse emulsion polymerization in the presence of CNT/graphenes.
2. De-doping and re-doping processes.
3. Very fast polymerization technique using sonication.
4. High conversion.
5. Homogenous and stable dispersions.

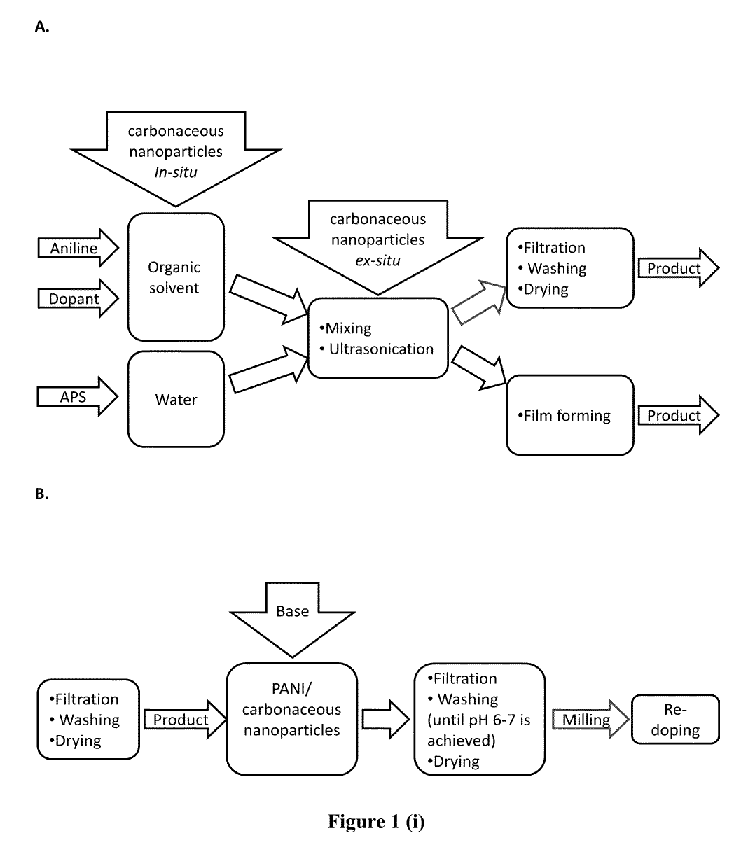

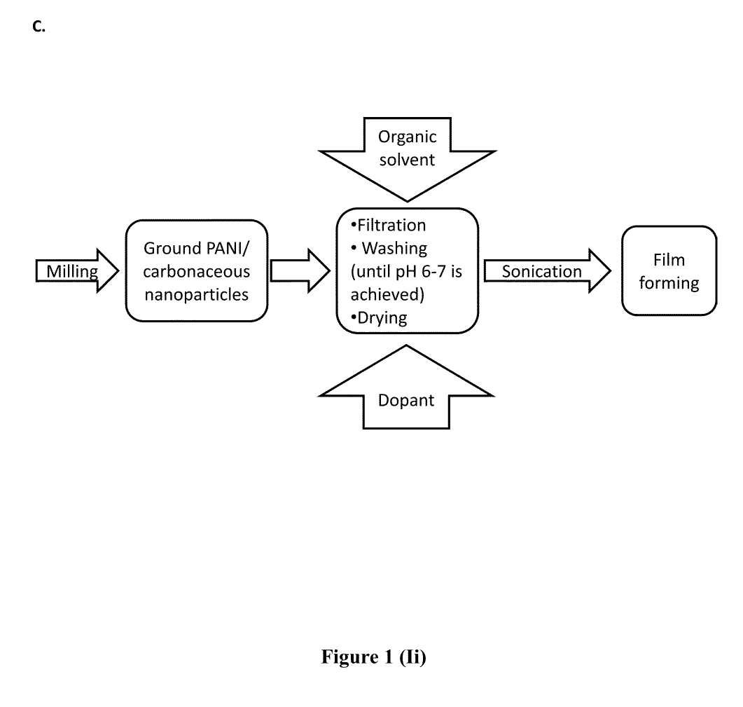

The process of the present invention is schematically illustrated in FIG. 1A-C. FIG. 1A illustrates that polymerization step. FIG. 1B illustrates the de-doping step. Figure C illustrates the re-doping step. Several embodiments of the process of the present invention will now be described in detail.

Step (a)—Polymerization:

Step (a) of the process involves polymerizing aniline and carbonaceous nanoparticles, e.g., CNT, graphene, carbon nanofibers or carbon black, by inverse emulsion polymerization conducted under sonication, so as to obtain PANI/carbon nano-composites. In some embodiments, the process involves mixing a solution comprising aniline and a dopant in an organic solvent, with an aqueous solution comprising a polymerization initiator/oxidizing agent, and adding the carbonaceous nanoparticles, wherein the carbonaceous nanoparticles can be added in situ, before polymerization begins, or ex situ, after polymerization ends.

Thus, in some embodiments, the process involves forming a solution of aniline and a dopant in an organic solvent. Different concentrations of aniline are added until a clear solution is formed.

A dopant, also called a doping agent, is a trace impurity element that is inserted into a substance in order to alter the electrical properties or the optical properties of the substance. Any dopant can be used in the process of the present invention. Non-limiting examples of suitable dopants are (±)-camphor-10-sulfonic acid (β) (CSA), para-toluene sulfonic acid (pTSA), dodecyl benzene sulfonic acid (DBSA), and linear-DBSA. Each possibility represents a separate embodiment of the present invention. Other suitable dopant materials are protonic acid dopants (e.g., hydrochloric acid (HCl), nitric acid (HNO₃), perchloric acid (HClO₄), sulfuric acid (H₂SO₄), and hydroiodic acid (HI)); naphthalene sulfonic acid (NSA), methanesulfonic acid (MSA), sulfonic acid of 3-pentadecylphenol (SPDP), sulfonic acid of 3-pentadecylanisole (SPDA), and sulfonic acid of 3-pentadecylphenoxy acetic acid (SPDPAA). Each possibility represents a separate embodiment of the present invention.

Any organic solvent can be used for this step. Suitable organic solvents include, but are not limited to halogenated hydrocarbons (e.g., dichloromethane, 1,2-dichloroethane, and chloroform), aromatic hydrocarbons (e.g., benzene, toluene, xylene), esters, ethers (e.g., diethyl ether, MTBE, diisopropyl ether, tetrahydrofuran (THF), 1,4-dioxane, 1,2-dimethoxyethane, and 1,2-diethoxyethane); phenolic compounds (e.g., phenol, o-cresol, m-cresol or p-cresol), N,N-dimethylformamide (DMF), N-methylpyrrolidone (NMP), dimethyl sulfoxide (DMSO), and any mixtures thereof. Currently preferred organic solvents include chloroform, toluene, xylene, NMP and m-cresol. Each possibility represents a separate embodiment of the present invention.

Next, an aqueous solution comprising a polymerization initiator is added to the above-described organic solution, as well as carbonaceous nanoparticles. The polymerization initiator (e.g., a strong oxidizing agent such as ammonium peroxydisulfate (APS)) is dissolved in water and mixed with the organic solvent formed in step (a), as illustrated in FIG. 1. Other polymerization initiators may be used, for example peroxy disulphate, potassium dichromate, potassium persulfate (KPS), sulfate ions, benzoyl peroxide, air oxygen as an oxidant in the presence of Cu(NO₃)₂, sodium persulfate and H₂O₂. Each possibility represents a separate embodiment of the present invention.

In some embodiments, the carbonaceous nanoparticles comprise carbon nanotubes (CNTs). In some representative embodiments, the CNT comprises single-walled carbon nanotubes (SWNT). In other embodiments, the CNT comprises double-walled carbon-nanotubes (DWNT). In other embodiments, the CNT comprises multi-walled carbon nanotubes (MWNT). In other embodiments, the carbonaceous nanoparticles comprise graphenes. In other embodiments, the carbonaceous nanoparticles comprise carbon nanofibers. In other embodiments, the carbonaceous nanoparticles comprise carbon black. Combinations of SWNT, DWNT, MWNT, carbon nanofibers, carbon black and/or graphenes are also contemplated. Each possibility represents a separate embodiment of the present invention.

The carbonaceous nanoparticles (e.g., CNT/graphene) may be added in situ prior to by initiation of polymerization. Alternatively, the carbonaceous nanoparticles may be added ex situ after polymerization ends. Each possibility is illustrated in FIG. 1A, and represents a separate embodiment of the present invention. The polymerization process is preferably an inverse emulsion polymerization which is conducted under sonication as described, e.g., in Suckeveriene et al. [15] or Zelikman et al. [16], the contents of each of which are hereby expressly incorporated by reference in their entirety.

An ultrasonic liquid processor is used to disperse the carbonaceous nanoparticles during or after polymerization. Sonication to disperse the carbonaceous nanoparticles in the aniline solution takes anywhere between about 30 seconds to about 10 or 15 minutes, typically about 5 minutes. Suitable sonication devices for use in this step include Vibra cell VCX 750 (Sonics and Materials Inc., Newtown, Conn.). Another suitable sonication devices are Qsonica Ultrasonic Liquid Processors, e.g., Sonicator Z1375 (Misonics Sonicators). This in situ polymerization method enables the production of wrapped and stabilized carbonaceous nanoparticles by PANI. As described above, the ultrasonic inverse emulsion polymerization of aniline in the presence of carbonaceous nanoparticles decreases agglomeration of carbonaceous nanoparticles, creating a micelle structure around the carbonaceous nanoparticles which becomes “soluble” in the organic solvent for a certain period of time. During this process, very small water dispersed droples formed by the ultrasonic field meet the continuous organic medium. At the interfaces, APS radicals in the aqueous droplets collide with the aniline/dopant complex dispersed in the organic phase, thus PANI forms at the interfaces. Since a large amount of interface is available, the polymerization rate is very fast. Moreover, the high-powered ultrasonic radiation assists in the creation of free radicals, thus contributing to the acceleration of the polymerization process.

Carbonaceous nanoparticle concentration in the PANI/carbon nano-composites is typically equal to or less than about 3% by weight of the aniline. In other embodiments, the concentration of carbonaceous nanoparticles is less than about 2.5%, 2%, 1.5% 1%, 0.5%, 0.25%, 0.1% or less by weight of the aniline, with each possibility representing a separate embodiment of the present invention.

Suitable ratios of aniline: dopant: polymerization initiator are about 1: 0.5-2: 0.1-0.5 respectively, for example 1:0.5:0.25, 1:1:0.25 or 1:2:0.25, respectively.

Steps (b) (de-doping) and (c) (re-doping):

As contemplated herein, the applicants have discovered that further treatment of the PANI/carbon nano-composites obtained in step (a), by de-doping (step b) followed by re-doping (step c), unexpectedly provides improved properties to the resulting nano-composites which enables the ultimate formation of conductive films with specifications and properties currently met only by ITO films.

In one embodiment, de-doping (step (b)) is achieved by a process comprising the steps of (i) removing the organic solvent; (ii) washing the resulting PANI/carbon solids with a base; (iii) filtering and washing with water until a neutral pH of about 6-7 is achieved; and (iv) drying.

Any base can be used for this step. A currently preferred base is ammonium hydroxide. Other suitable bases include, but are not limited to alkali metal and alkaline earth carbonates and hydroxides, for example potassium bicarbonate, sodium bicarbonate, potassium carbonate, sodium carbonate, sodium hydroxide, potassium hydroxide, calcium hydroxide, and the like; tertiary amines such as triethylamine, tributylamine, diisopropylethylamine, N-methylmorpholine, pyridine, lutidine, DBN, DBU and the like; and basic resins. Each possibility represents a separate embodiment of the invention.

In some embodiments, the de-doped PANI/carbon solids are subjected to grinding using conventional grinding techniques, e.g., a ball mill or a mortar and pestle, or impact milling such as pin milling. Dry milling with an air jet and wet milling with a pearl mill are also contemplated. Other grinding/milling techniques are described, e.g., by Niwa et al. [18], Rajkhowa et al. [19], Stein et al. [20], Rubio-Marcos et al. [21], and WO 2010/121328, the contents of each of which are expressly incorporated by reference in their entirety as if fully set forth herein.

The de-doped PANI/carbon nano-composite is then re-doped by adding a dopant (any one of the dopants described above may be used, preferably CSA, pTSA, or DBSA), in any organic solvent as described above. m-Cresol is a currently preferred solvent for the re-doping stage.

### Step (d):

In step (d), the re-doped PANI/carbon nano-composites are used to form a film using a series of coating rods to produce films of different thicknesses as desired, followed by drying at elevated temperatures, e.g., about 80° C. to about 150° C., preferably about 120° C., for about 1 to 10 minutes, typically for about 5 minutes. Suitable rods for this purpose are K Hand Coater Large Starter Set, RK Print Coat Instruments, UK, Chemsultants International Inc. (http://www.chemsultants.com/testing-equipment-products/sample-preparation-devices/wire-wound-coating-rods.aspx), NS Precision Coating Rods (http://precisioncoatingrods.com/). Coating techniques that may be used for this step include Air brush coatings [22], Dr. Blade (http://printwiki.org/Doctor_Blade), and Roll-to-roll [23]. Additional coating techniques are described in [24] and [25]. The contents of each of these references are hereby expressly incorporated by reference herein.

In some embodiments, the conductive PANI/carbon nano-composite film obtained by the aforementioned process has a surface resistivity of equal to or less than about 1,000 Ω/□, preferably equal to or less than about 650 Ω/□, more preferably equal to or less than about 500 Ω/□, most preferably equal to or less than about 100 Ω/□. This makes the film suitable as conductive films for various commercial applications including, but not limited to as touch screens, photovoltaic cells, flexible displays, gas sensors, dielectric devices, nanoelectronic devices, nano-composites, emitters, supercapacitors, fuel cells, sensors, actuators (e.g., electroactive paper actuators), cathodes in several types of batteries such as lithium metal-polymer batteries, etc. Other potential uses for the PANI/carbon nano-composite films of the present invention include, but are not limited to nanotube-based transistors, memory circuits and electronic circuits.

The conductive PANI/carbon nano-composite film has a transparency of equal to or greater than about 80%. In some embodiments, the transparency is greater than about 85%, greater than about 90% or greater than about 95%. Each possibility represents a separate embodiment of the present invention.

The conductive PANI/carbon nano-composite film has a haze of equal to or less than about 10%. In some embodiments, the haze is less than about 8%, less than about 6% or less than about 4%. Each possibility represents a separate embodiment of the present invention.

In another embodiment, the conductive PANI/carbon nano-composite film has a thickness of equal to or less than about 1,200 nm. In some embodiments, the conductive PANI/carbon nano-composite film has a thickness of equal to or less than about 1,000 nm. In some embodiments, the conductive PANI/carbon nano-composite film has a thickness of equal to or less than about 500 nm. In some embodiments, the conductive PANI/carbon nano-composite film has a thickness of equal to or less than about 250 nm. Each possibility represents a separate embodiment of the present invention.

Another advantage of the PANI/carbon nano-composite films of the present invention is their flexibility, in contrast to the commercially available ITO films which tend to be brittle.

As explained above, the PANI/carbon nano-composite films of the present invention can be applied to a multiplicity of substrates, for example silica, silicone, germanium, polyethylene terphthalate (PET), glass, polyamides, and paper. Each possibility represents a separate embodiment of the present invention.

Definitions:

Carbon nanotubes (CNTs) are allotropes of carbon with a cylindrical nanostructure. These cylindrical carbon molecules have unusual properties, which are valuable for nanotechnology, electronics, optics and other fields of materials science and technology. In particular, owing to their extraordinary thermal conductivity and mechanical and electrical properties, carbon nanotubes find applications as additives to various structural materials.

The term “single walled carbon nanotubes” (SWNT) as used herein refers to a cylindrically shaped thin sheet of carbon atoms having a wall which is essentially composed of a single layer of carbon atoms which are organized in a hexagonal crystalline structure with a graphitic type of bonding.

The term “double walled carbon nanotubes” (DWNT) as used herein refers to a coaxial structure, containing two concentric graphene cylinders. DWNTs form a special class of nanotubes because their morphology and properties are similar to those of SWNT but their resistance to chemicals is significantly improved. Double-walled carbon nanotubes typically have higher thermal and chemical stability than single-walled carbon nanotubes, and can be applied to gas sensors, dielectric devices, nanoelectronic devices, nano-composites and emitters etc.

Multi-walled nanotubes (MWNT) consist of multiple rolled layers (concentric tubes) of graphene. There are two models that can be used to describe the structures of multi-walled nanotubes. In the Russian Doll model, sheets of graphite are arranged in concentric cylinders, e.g., a (0,8) single-walled nanotube (SWNT) within a larger (0,17) single-walled nanotube. In the Parchment model, a single sheet of graphite is rolled in around itself, resembling a scroll of parchment or a rolled newspaper. The interlayer distance in multi-walled nanotubes is close to the distance between graphene layers in graphite. The Russian Doll structure is observed more commonly. Its individual shells can be described as SWNTs, which can be metallic or semiconducting.

Graphenes are also allotropes of carbon. Their structure is one-atom-thick planar sheets of sp2-bonded carbon atoms that are densely packed in a honeycomb crystal lattice. The crystalline or “flake” form of graphite consists of many graphene sheets stacked together. Graphene is the basic structural element of some carbon allotropes including graphite, charcoal, carbon nanotubes and fullerenes.

A nanotube is characterized by having one of its dimensions (referred to as the length of the nanotube) elongated with respect to the other dimension (which is characterized by its diameter). It is to be understood that the term “nanotubes” as used herein refers to structures in the nanometer as well as micrometer range.

According to various embodiments, the carbon nanotubes of the present invention have diameters ranging from about 0.6 nanometers (nm) to about 200 nm and lengths ranging from about 50 nm to about 10 millimeters (mm). More preferably, the carbon nanotubes have diameters ranging from about 0.7 nm to about 100 nm and lengths ranging from about ranging from about 250 nm to about 1 mm. Even more preferably, the carbon nanotubes have diameters ranging from about 0.8 nm to about 50 nm and lengths ranging from about 0.5 micrometer (μm) to about 100 μm. Most preferably, the carbon nanotubes of the present invention have diameters ranging from about 0.9 nm to about 10 nm and lengths ranging from about 1 μm to about 50 μm.

The term “polyaniline” or PANI as used herein is generally known to have the following chemical structure:

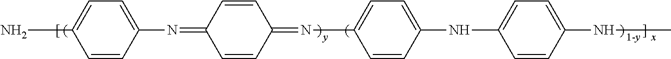

PANI consists of two structural units, the benzoid diamine and the quinoid diimine. PANI possesses three readily accessible oxidation states. These range from the fully reduced (y=1) leucoemeraldine state to the half oxidized (y=0.5) emeraldine form to the fully oxidized (y=0) pernigraniline state. The emeraldine base is insulating, but its iminic nitrogen sites can be protonated by strong acids to form an electrically conductive acid-base complex called emeraldine salt or doped (protonated) emeraldine.

According to the principles of the present invention the PANI/carbon nano-composite film is conducting or semiconducting. The terms “conducting”, “conductive”, “semiconducting” or “semiconductive” as used herein refer to organic materials with an electrical conductivity ≧as follows (http://www.eddy-current.com/condres.htm):
Metals: σ about >105 (Ω.m)-1
Semiconductors: about 10-6<σ<105 (Ω.m)-1
Insulators: σ about <10-6 (Ω.m)-1

All referenced cited herein are hereby expressly incorporated by reference in their entirety as if sully set forth herein.

Tape test, ASTM 3359D refers to well known procedures for assessing the adhesion of coating films to metallic substrates by applying and removing pressure-sensitive tape over cuts made in the film. These test methods are used to establish whether the adhesion of a coating to a substrate is at an adequate level, and can be carried out by methods known to a person of skill in the art.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

Experimental Details Section

### EXAMPLE 1

### Preparation of Hybrid PANI/CNT Nano-Composites for Preparation of Thin, Transparent, and Conductive Films

### Materials

Aniline monomer and aniline dimer was used after purification (Aldrich, USA) were used without further purification. (±)-camphor-10-sulfonic acid (13) (CSA) (Riedel de-Haën, Sigma-Aldrich, Germany), para-toluene sulfonic acid (pTSA) (Aldrich, USA), Dodecyl benzene sulfonic acid (DBSA), and linear-DBSA (Zohar, Israel) were used as received without further purification. Toluene, chloroform (Bio Lab LTD., Israel), xylene (Frutarom LTD., Israel), N-methyl pyrrolidone (NMP) (Merck KGaA, Germany), and m-cresol (Flucka chemie, Switzerland) were used as solvents. Nine different nanotubes, shown in Table 1, were studied: two types of single walled two types of double walled, and five types of multi walled carbon nanotubes. Ammonium peroxydisulfate (APS) was used as received (Riedel de-Haën, Sigma-Aldrich, Germany). Methyl alcohol, ethyl alcohol 95%, 1-butanol, 2-propanol (Frutarom LTD., Israel), ethyl alcohol 96% (Gadot chemicals, Israel), 1-pentanol (Flucka chemie, Switzerland), and iso-propyl alcohol (Finkelman LTD., Israel) were used for washing the films.

TABLE 1
Studied nanotubes

| | | Diameter | Length | Carbon purity | Surface Area | | |
|---|---|---|---|---|---|---|---|
| | Type | [nm] | [μm] | [%] | [m²/gr] | Company | Comments |
| N-7000 | MWNT | 9.5 | 1.5 | 90 | 250-300 | Nanocyl, Belgium | |
| N-1000 | SWNT | 2 | several | >70 | >1000 | Nanocyl, Belgium | |
| N-1101 | SWNT | 2 | several | >70 | >1000 | Nanocyl, Belgium | >5% —COOH |
| N-2100 | DWNT | 3.5 | 1-10 | >90 | >500 | Nanocyl, Belgium | |
| N-2101 | DWNT | 3.5 | 1-10 | >90 | >500 | Nanocyl, Belgium | <1% —COOH |
| N-3100 | thin | 9.5 | 1.5 | >95 | n/a | Nanocyl, Belgium | |
| | MWNT | | | | | | |
| Aligned | Aligned | 10-20 | 5-15 | >95 | 40-300 | NanoAmor, USA | |
| MWNT | MWNT | | | | | | |
| Highly | MWNT | 50-100 | 5-10 | >95 | n/a | NanoAmor, USA | |
| conductive | | | | | | | |
| MWNT | | | | | | | |
| Baytubes | MWNT | 13-16 | 1->10 | >95 | n/a | Bayer, Germany | |
| C 70 P | | | | | | | |

### Preparation of Nano-Composites

The inverse emulsion polymerization procedure of aniline in an organic solvent was conducted as shown in [15-17]: a certain amount of dopant (CSA, pTSA or DBSA) was dissolved in 20 ml organic solvent (chloroform, toluene, xylene, NMP, m-cresol) using magnetic stirring. Different concentrations of distilled aniline were added and a clear solution formed. Vibra cell VCX 750 (Sonics & Materials Inc., USA) ultrasonic liquid processor was used to disperse the CNT and to accelerate the polymerization process. CNT were added in-situ, before polymerization begins, to the organic solution. CNT concentration ranges from 0.05 to 0.25%wt of the dispersion. Ammonium peroxydisulfate (APS) dissolved in 1 ml distilled water, was added to the solvent/aniline solution followed by sonication at 4° C. for 0-15 min.

The PANI/CNT samples were then de-doped as follows: after the solvent was evaporated, a 25%vol ammonium hydroxide solution was added to the doped-PANI/CNT solids, for 1 hr. the solids were then filtered and washed with distilled water until neutral pH is achieved, followed by overnight vacuum drying at 80° C. The de-doped PANI/CNT solids were ground and re-doped in m-cresol with CSA, under sonication.

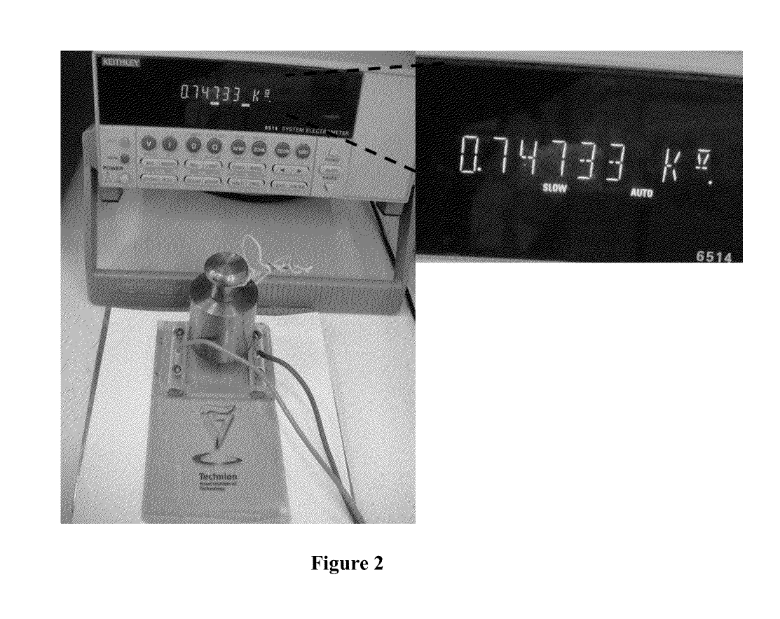

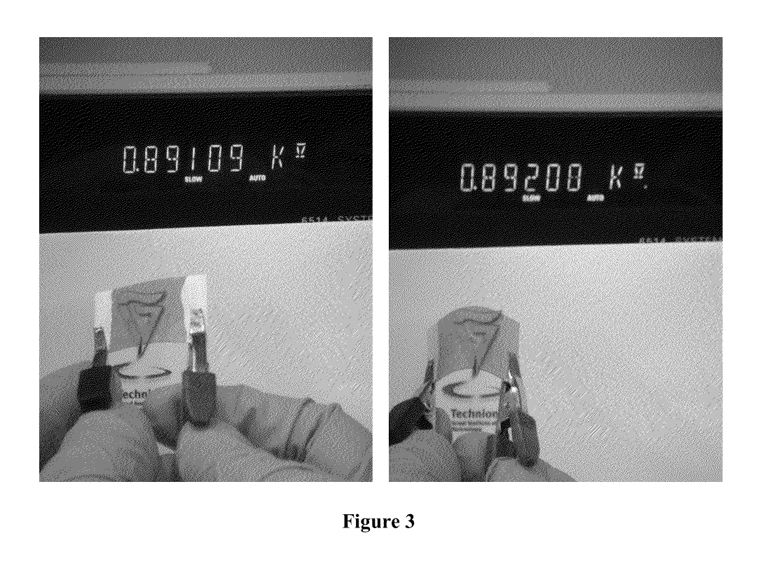

The re-doped PANI/CNT dispersion then served for film formation using a series of coating rods to produce films of different thicknesses (K Hand Coater Large Starter Set, RK Print Coat Instruments, UK) followed by drying at 120° C. for 5 minutes. A reference sample without CNT was prepared using the same procedure. The molar ratios of aniline:dopant:APS are preferably about 1:0.5:0.25, 1:1:0.25, or 1:2:0.25, respectively. Scale-up of these nano-composites was performed successfully. The films were rinsed with different alcohols to remove reactants excess. FIG. 2 shows an image of thin, transparent and highly conductive film (value shown ˜747 Ω/□) produced by the polymerization process of the present invention. FIG. 3 shows a flexible, thin, transparent and highly conductive film (values shown ˜891-892 Ω/□) produced by the polymerization process of the present invention. The reported values are higher than actual values due to high contact resistivity.

A comparison of properties of PANI/CNT films produced by the process of the present invention and conventional ITO films is provided in Table 2. As shown, PANI/CNT films are comparable to ITO films and meet the requirements of thin transparent films in terms of surface resistance, transparency, and adhesion.

TABLE 2

| | | ITO coated PET |
|---|---|---|
| | | (Zhuhai Kaivo Electronic |
| | | Components Co., |
| | PANI/CNT coated PET | Ltd., China) |
| Surface Resistance | 94.6 | 45 |
| [ohm/sq] | | |
| Transmittance | 81.8 | 84 |
| Haze (%) | 4.9 | 1 |
| Adhesion | good | good |
| Thickness | <1.2 μm | 125 μm |
| Price per square | 1.25-2.5 USD = 5-10 | 59 USD = 225 NIS* |
| meter | NIS* | (commercial product) |
| | (materials only) | |

*NIS: New Israeli Shequels.
PET: polyethylene terphthalate.

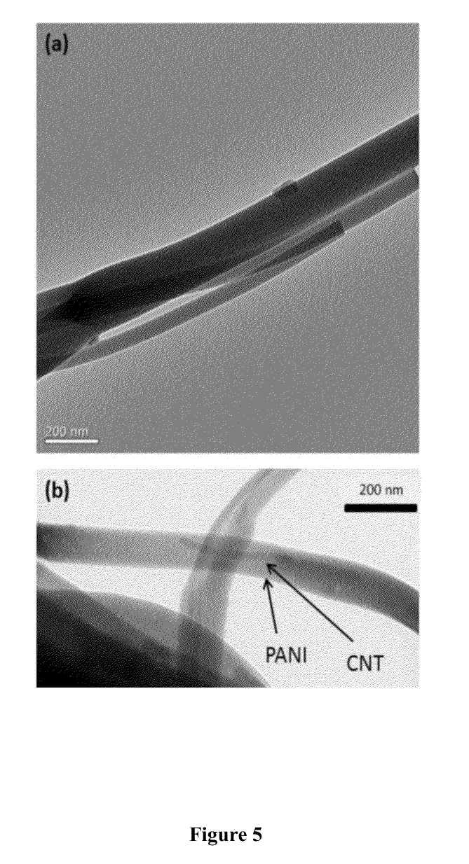

FIG. 5 depicts transmission electron microscopy (TEM) images of sprayed dispersions: A) neat PANI and B) PANI/CNT, polymerized in toluene. FIG. 5A shows neat PANI fibers with diameters of 60 to 180 nm. These fibers were spontaneously created during dispersion spraying using N₂ flow. FIG. 5B shows several PANI/CNT fibers, where nanotubes are embedded within the PANI fibers. The top fiber was intensely irradiated. Since only PANI decomposes when irradiated, it is possible to distinguish between PANI and CNT. The PANI fiber exhibits a diameter of ˜86 nm whereas the nanotube diameter is ˜22 nm.

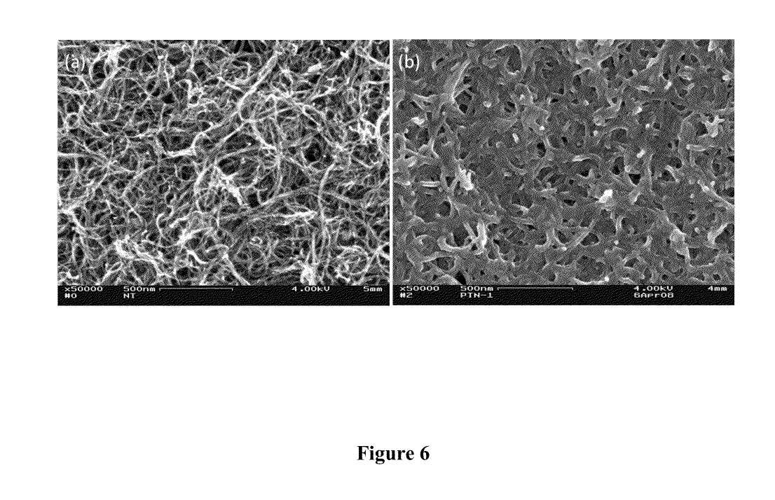

FIG. 6 depicts high-resolution scanning electron microscopy (HRSEM) of A) Neat MWNT and B) MWNT/PANI. FIG. 6A shows a MWNT dried dispersion where the CNT dispersion is poor with many cavities and no obvious network can be seen. The CNT have an average diameter of ˜20 nm. FIG. 6B depicts HRSEM images of PANI coated MWNT. The surface of the dried MWNT (FIG. 6A) has been changed, and it appears similar to the surface of neat PANI. The MWNT/PANI tube has an average diameter of ˜37 nm, showing that the tubes were coated with PANI. It can also be seen in FIG. 6B that a uniform network was formed, unlike the pristine MWNT shown in FIG. 6B.

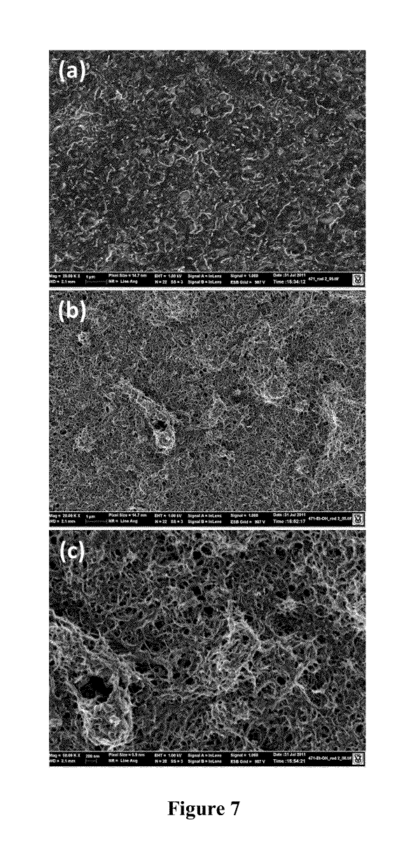

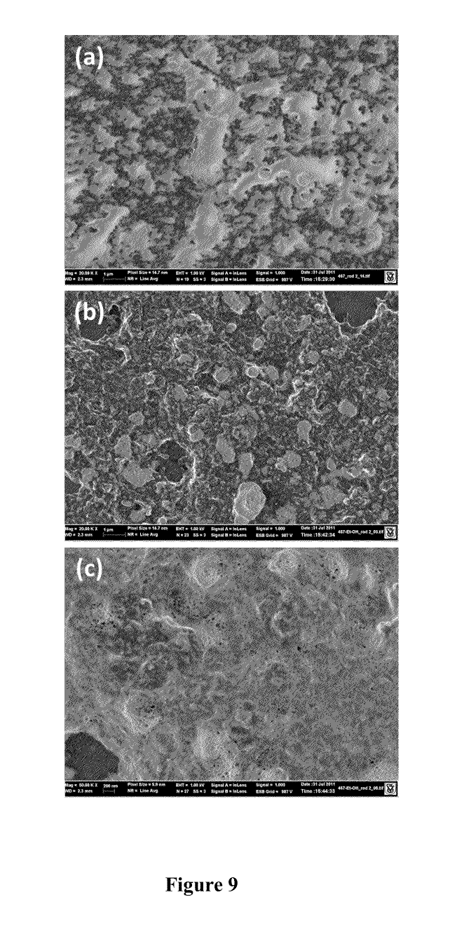

FIG. 7 depicts HRSEM images of dry film deposited from PANI/CNT dispersion A) before and B, C) after post treatment. The bright dopant fraction disappears after treated, similar to the PANI film (FIG. 9B and C). The smooth surface of the unwashed films (FIG. 7A) changes to a highly porous CNT network. In FIG. 7C the PANI is clearly coated the CNT, as reported elsewhere [15, 16]. It is suggested that the high porosity structure of both treated PANI and PANI/CNT films affects the film resistivity, transparency and haze. Since the dopant is an electric insulator, its excess in the untreated films increases the contact resistivity between the conducting fractions, thus increasing the total film resistivity. When the excess dopant is removed, more conductive contacts are available, thus reducing dramatically the films resistivity. Also, the porous structure for the treated films allows more light transparency, compared with the untreated films. Thus, the film transparency increases while the haze reduces [1].

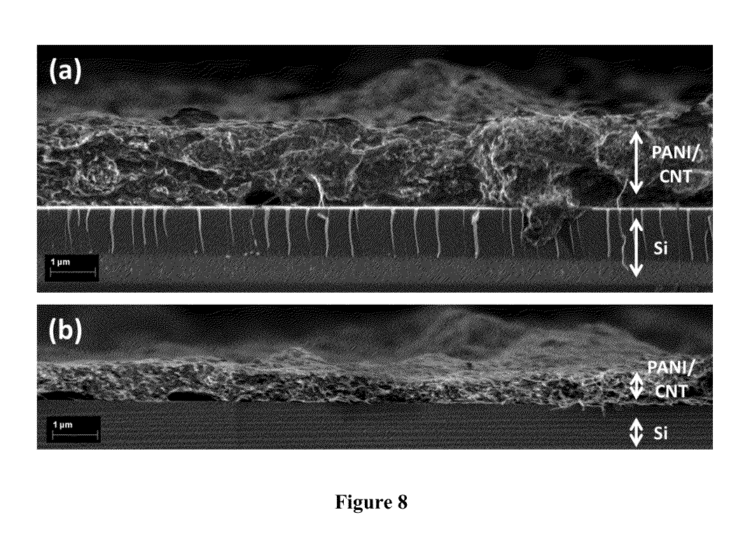

FIG. 8 depicts HRSEM images of dry film cross-section deposited from PANI/CNT dispersion A) before and B) after post treatment. The untreated film (FIG. 8A) exhibits both bright dopant and dark PANI/CNT fractions, similar to the top viewed PANI film (FIG. 8A). The bright DBSA fraction disappears after treated. The unwashed and washed PANI/CNT films thickness are 1.8 and 0.6 μm, respectively, i.e. the film thickness decreases by ˜300%. The amount of DBSA is 0.6 times larger than the amount aniline and CNT, thus the washed film thickness was expected to be ˜0.7 μm. The presented CNT (nanocyl N-7000) have a large surface area (250-300 m2/g). Since PANI is coating the CNT homogenously, the structure is more porous, compared with treated PANI film.

FIG. 9 depicts HRSEM images of dry film deposited from PANI emulsion A) before and B, C) after post treatment. The bright dopant fraction disappears after treated. The smooth surface of the untreated film (FIG. 9A) changes to a highly porous structure due to the removal of dopant (FIG. 9B and C).

### EXAMPLE 2

### Preparation of Hybrid PANI/Graphene Nano-Composites

The procedure of Example 1 was followed, using graphene particles instead of CNTs. Table 3 depicts the various graphene particles used for these studies. Similar results to those of Example 1 were obtained.

TABLE 3
Graphenes

| | | Average | | | |
|---|---|---|---|---|---|
| | Flack | Particle | | | |
| | Thickness | (lateral) size | Carbon purity | Surface Area | |
| | [nm] | [μm] | [%] | [m²/gr] | Company |
| C-1 | 5-30 | 5-25 | 97 | 60 | Graphene Nanopowder, USA |
| AO-3 | 12 | 1.5-10 | 99.2 | 80 | Graphene Nanopowder, USA |
| AO-4 | 60 | 3-7 | 98.5 | <15 | Graphene Nanopowder, USA |
| MO-1 | 28 | na | 99.9 | 60 | Graphene Nanopowder, USA |
| xGnP M-5 | 6-8 | 5 | 99.5 | 120-150 | XG Sciences, USA |
| xGnP M-25 | 6-8 | 25 | 99.5 | 120-150 | XG Sciences, USA |

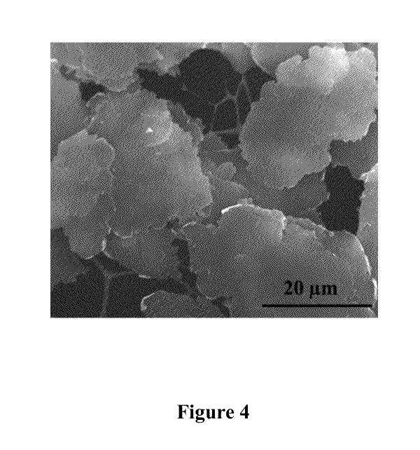

FIG. 4 is a representative image of one type of graphene particles used in the process of the present invention.

Using similar procedures, carbon black and carbon nanofibers may also be used in the process of the present invention, with similar results.

While certain embodiments of the invention have been illustrated and described, it is clear that the invention is not limited to the embodiments described herein. Numerous modifications, changes, variations, substitutions and equivalents will be apparent to those skilled in the art without departing from the spirit and scope of the present invention as described by the claims, which follow.

### REFERENCES

1. Geng H.-Z., Kim K. K., So K. P., Lee Y. S., Chang Y. and Lee Y. H., Journal of the American Chemical Society, 2007, 129, 7758-7759.
2. Hecht D. S., Hu L.-B. and Irvin G., Advanced Materials (Weinheim, Germany), 2011, 23, 1482-1513.
3. Hosono H., Ohta H., Orita M., Ueda K. and Hirano M., Vacuum, 2002, 66, 419-425 .
4. Wassei J. K. and Kaner R. B., Mater Today (Oxford, UK), 2010, 13, 52-59.
5. Suckeveriene R. Y., Zelikman E., Mechrez G. and Narkis M., Reviews in Chemical Engineering, 2011, 27, 15-21.
6. Suckeveriene R. Y., Zelikman E. and Narkis M.: Hybrid Electrically Conducting Nano-composites Comprising Carbon Nanotubes/Intrinsically Conducting Polymer Systems. Hoboken, N.J.: John Wiley & Sons, Inc.; 2012.
7. S. Iijima, Letters to Nature 1991, 354, 56.
8. M. Ginic-Markovic, J. G. Matisons, R. Cervini, G. P. Simon, P. M. Fredericks, Chem. Mater. 2006, 18, 6258.
9. E. Zelikman, M. Narkis, A. Siegmann, L. Valentini, J. M. Kenny, Polymer Eng. Sci. 2008, 48, 1872.
10. R. Y. Suckeveriene, A. Tzur, M. Narkis, A. Siegmann, Polym. Compos. 2007, 30, 422.
11. E. N. Konyushenko, J. Stejskal, M. Trchova, J. Hradil, J. Kovarova, J. Prokes, M. Cieslar, J.-Y. Hwang, K.-H. Chen, I. Sapurina, Polymer 2006, 47, 5715.
12. D.-J. Guo, H.-L. Li, J. Solid State Electrochem. 2005, 9, 445.
13. H. Zhang, H. X. Li, H. C. Cheng, J. Phys. Chem. B 2006, 110, 9095.
14. B. G. Soares, M. E. Leyva, G. M. O. Barra, D. Khastgir, Eur. Polymer J. 2006, 42, 676.
15. Zelikman E., Suckeveriene R. Y., Mechrez G. and Narkis M., Polymers for Advanced Technologies, 2010, 21, 150-152.
16. Suckeveriene R. Y., Zelikman E., Mechrez G., Tzur A., Frisman I., Cohen Y. and Narkis M., Journal of Applied Polymer Science, 2011, 120, 676-682.
17. Suckeveriene R. Y., Mechrez G., Hachamo Filiba O., Mosheev S. and Narkis M., Journal of Applied Polymer Science, Accepted 26.7.2012, DOI: 10.1002/APP.38405.
18. Niwa, T., Miura, S., Danjo, K. International Journal of Pharmaceutics, 2011, 405 218-227.
19. Rajkhowa, R., Wang, L., and Wang, X. Powder Technology, 2008, 185 87-95.
20. Stein, J., Fuchs, T., Mattern, C. Chem. Eng. Technol. 2010, 33, No. 9, 1464-1470.
21. Rubio-Marcos, F.; Romero, J. J.; Martin-Gonzalez, M. S.; Fernandez, J. F., J. Eur. Ceram. Soc. 2010, 20(13), 2763-2771.
22. Gianpaolo, S. et al. Solar Energy Materials & Solar Cells, 2011, 95, 1775-1778.
23. Sukang Bae et al. Nature Nanotechnology, 2011, 5, 574-578.
24. Coatings Technology Handbook, third ed., CRC, Taylor and Francis 2006, ISBN 1-57444-649-5.
25. Progress in Organic Coatings (2006), 55, (3), 301. Publisher: (Elsevier B.V.,) CODEN:POGCAT ISSN:0300-9440.

What is claimed is:

1. A polyaniline (PANI)/carbon nano-composite conductive film comprising carbonaceous nanoparticles and PANI, which is characterized by
a surface resistivity of equal to or less than about 1,000 Ω/□
a transparency of equal to or greater than about 80%;
haze of equal to or less than about 10%; and
which is adherable to a substrate (pass tape test, ASTM 3359D).

2. The conductive PANI/carbon nano-composite film according to claim 1, wherein the film has a thickness of equal to or less than about 1,200 nm.

3. The conductive PANI/carbon nano-composite film according to claim 1, wherein the concentration of CNT in said conductive PANI/carbon nano-composite film is equal to or less than about 3%.

4. The conductive PANI/carbon nano-composite film according to claim 1, wherein the carbonaceous nanoparticles are selected from carbon nanotubes (CNTs), graphene, carbon black and carbon nanofibers.

5. The conductive PANI/carbon nano-composite film according to claim 4, wherein said CNT is selected from the group consisting of single-walled carbon nanotubes (SWNT), double-walled carbon-nanotubes (DWNT), multi-walled carbon nanotubes (MWNT), and any combination thereof.

6. A composition comprising the PANI/carbon nano-composite film according to claim 1, adhered onto a substrate.

7. The composition according to claim 6, wherein the substrate is selected from the group consisting of silica, silicone, germanium, polyethylene terphthalate (PET), glass, polyamides and paper.

8. A process for preparing the PANI/carbon nano-composite film according to claim 1, the process comprising the steps of:
(a) polymerizing aniline and carbonaceous nanoparticles by inverse emulsion polymerization conducted under sonication, so as to obtain PANI/carbon nano-composites;
(b) de-doping the PANI/carbon nano-composites obtained in step (a);
(c) re-doping the PANI/carbon nano-composites obtained in step (b); and
(d) forming a film from the re-doped PANI/carbon nano-composites.

9. The process according to claim 8, wherein step (a) comprises (i) forming a solution of aniline and a dopant in an organic solvent; and (ii) adding a polymerization initiator and carbonaceous nanoparticles, wherein the carbonaceous nanoparticles are added in situ prior to by initiation of polymerization, or ex situ after polymerization.

10. The process according to claim 9, wherein the dopant is selected from the group consisting of (±)-camphor-10-sulfonic acid (β) (CSA), para-toluene sulfonic acid (pTSA), Dodecyl benzene sulfonic acid (DBSA), and linear-DBSA.

11. The process according to claim 9, wherein the polymerization initiator is an oxidizing agent.

12. The process according to claim 11, wherein the oxidizing agent is ammonium peroxydisulfate (APS).

13. The process according to claim 8, wherein the de-doping step (b) comprises (i) removing the organic solvent; (ii) washing the resulting PANI/carbon solids with a base; (iii) filtering and washing with water until a pH of about 6-7 is achieved; and (iv) drying.

14. The process according to claim 13, further comprising the step of grinding the de-doped PANI/carbon solids.

15. The process according to claim 8, further comprising the step of adhering the PANI/carbon nano-composite film onto a substrate.

16. The process according to claim 15, wherein the substrate is selected from the group consisting of silica, silicone, germanium, polyethylene terphthalate (PET), glass, polyamides and paper.

17. A polyaniline (PANI)/carbon nano-composite conductive film according to claim 1, which is prepared in accordance with a process comprising the steps of:
(a) polymerizing aniline and carbonaceous nanoparticles by inverse emulsion polymerization conducted under sonication, so as to obtain PANI/carbon nano-composites;
(b) de-doping the PANI/carbon nano-composites obtained in step (a);
(c) re-doping the PANI/carbon nano-composites obtained in step (b); and
(d) forming a film from the re-doped PANI/carbon nano-composites.
